(19) United States
(12) Patent Application Publication
(10) Pub. No.: US 2026/0187711 A1
(43) Pub. Date: Jul. 2, 2026

(54) AUTOMATICALLY GENERATING REPRESENTATIVE IMAGES FOR ITEM CATEGORIES USING A GENERATIVE VISUAL LANGUAGE MODEL

(71) Applicant: Maplebear Inc., San Francisco, CA (US)

(72) Inventors: Prithvishankar Srinivasan, Seattle, WA (US); Shayaan Nadeem, Toronto (CA); Danna Weintraub, San Francisco, CA (US); Shishir Kumar Prasad, San Ramon, CA (US)

(21) Appl. No.: 19/007,413

(22) Filed: Dec. 31, 2024

(51) Int. Cl. G06Q 30/0601; G06T 11/00; G06V 10/40

(52) U.S. Cl. CPC G06Q 30/0643; G06T 11/00; G06V 10/40

(57) ABSTRACT

An online system maintains a database of items offered by the system, where the items are organized in a catalog by item categories. To generate an image for an item category without biasing the image for the item category image by branded items within the item category, the online system obtains a set of example images of items in the item category. Based on the set of example images, the online system prompts a multimodal large language model (LLM) to generate a generic description of the set of example images representing the item category. The online system prompts an image generative model to generate an example of an item within the category using the generic description from the LLM. The generated image may be evaluated and stored by the online system connection with the item category.

### BACKGROUND

Various online systems offer items for acquisition by users, with a user selecting one or more items through interaction with the online system. For example, a user includes one or more items in an order by selecting items via one or more interfaces generated and presented by the online system. Subsequently, the user receives the selected items included in the order from the online system. For example, the online system allocates an order from a user to a picker who obtains items included in the order from a source and delivers the obtained items to a location included in the order.

To simplify identification and selection of items by users, many online systems organize items into item categories. An item category includes similar items, such as items each having one or more common attributes. In response to receiving a selection of an item category from a user, the online system retrieves items within the item category and presents the items within the item category to a user.

Many online systems display text descriptions, such as text names, of item categories to users to identify different item categories. Displaying representative images corresponding to different item categories would simplify selection of an item category for various users. However, manually creating images for different item categories is time and resource intensive, making manual creation of such representative images impractical. Conversely, leveraging stock images of one or more items for representative images of different item categories often results in a representative image that does not accurately represent items within one or more item categories, complicating user identification of one or more items.

While many online systems store information describing prior interactions by users with items, conventional online systems do not accurately leverage this data to aid with identifying different item categories. Although an online system may use prior interactions with items in an item category to select an image of an item having at least a threshold amount of prior interaction with the user as the representative image for the item category, such a representative image can subsequently influence items selected from the item category by users. For example, using an image of a specific item as a representative image of an item category often increases a likelihood of users selecting the specific item or items having one or more common attributes as the specific item (e.g., a common manufacturer) from the item category. This prevents conventional online systems from efficiently leveraging stored interactions with items to aid in determining representative images for item categories.

### SUMMARY

In accordance with one or more aspects of the disclosure, the online system has access to various items. In some embodiments, the online system has access to items available from one or more sources and allows users to select one or more items available from a source. For example, the online system receives a selection of a source and an order from a user, with the order including one or more items available from the selected source. Subsequently, the online system obtains the items included in the order from the selected source, and the obtained items are delivered to a location specified by the order. As another example, the online system directly provides items to users, so the online system receives an order including one or more items from a user and provides items in the order to the user.

To simplify identification or selection of items by users, the online system maintains information describing various items accessible to the online system. In various embodiments, the online system maintains one or more item catalogs identifying items accessible to the online system. For example, the online system maintains an item catalog for each source from which the online system accesses items. The item catalog for a source includes items accessible to the online system from the source. Alternatively, the online system maintains a single item catalog identifying items provided by the online system or otherwise accessible to the online system. An item catalog identifies attributes of each item accessible to the online system and descriptive information about each item accessible to the online system.

In various embodiments, the online system organizes an item catalog as a taxonomy having a hierarchical structure. Such a taxonomy has multiple levels, with different levels including different levels of detail about items. For example, a level of the taxonomy comprises an item category including items having one or more common attributes, and a lower level of the taxonomy from the item category identifies individual items within the item category. Alternatively, the online system maintains multiple item categories, with each item category including one or more items, such as items having one or more common attributes.

In various embodiments, the online system displays information describing different item categories to a user so the user may select an item category to view items within the selected item category. For example, the online system identifies item categories by displaying their corresponding text names or text descriptions to a user. However, displaying images corresponding to different item categories allows a user to more easily differentiate between different item categories or to select an item category. Maintaining a representative image for different categories allows display of representative images for one or more item categories to users to aid in identification or selection of an item category.

Although the online system often maintains images of items in one or more item categories, selecting an image of a specific item within the item category as the representative image for the item category may bias users to selecting the item used as the representative image or to selecting items having one or more attributes matching attributes of the item used as the representative image. For example, users may more frequently select items associated with a brand (e.g., a manufacturer, a distributor) that included in an image of an item used as a representative image of the item category.

The online system may attempt to mitigate the influence of one or more attributes of items (e.g., a brand) when determining representative images for one or more item categories by manually-creating a representative image for an item category. However, manually creating images for item categories is time-intensive and resource-intensive, making it impractical to scale as a number of item categories increases or as a number of items in item categories increases. Alternatively, the online system may use stock images or photographs of items as representative images for item categories. While using stock images or photographs may mitigate potential bias from attributes of items included in the representative image, stock images or photographs may inaccurately represent items included in the item category. Inaccuracies between a representative image for an item category and items included in the item category reduce a frequency with which users select items from the item category for inclusion in orders or reduces a frequency with which users interact with the online system to select items.

To automate generation of a representative image for an item category including one or more items, while preventing presentation of one or more specific attributes of items in the item category, the online system identifies the item category. For example, the online system retrieves an item catalog maintained for a source and identifies the item category from the item catalog. Alternatively, the online system identifies the item category from an item catalog identifying items offered by the online system. The item category includes items as well as attributes of each item. In various embodiments, the item category also includes an image associated with each item. Multiple images may be associated with one or more items in the item catalog in various embodiments.

The online system receives interactions by users with various items. For example, the online system receives interactions from users selecting one or more items for inclusion in one or more orders. As another example, the online system receives requests from users for additional information about one or more items. In an additional example, the online system receives requests from users to store one or more items in one or more lists associated with corresponding users.

As users perform interactions with items, the online system stores information describing interactions by users with items. For example, the online system stores an entry for each interaction, with an entry including an identifier of a user, an identifier of an item, and a type of interaction by the user with the item. In some embodiments, an entry also includes a time when the user performed the interaction and may include a source from which the item is retrieved. Maintaining information about interactions by users with items accessible through the online system allows evaluation of rates of interaction by users with various items.

The online system retrieves historical interactions by users with items within the item category stored by the online system. Based on the historical interactions with the items within the item category, the online system selects a set of representative items for the item category. In various embodiments, the online system determines a count of a specific type of interaction by users with each item within the item category. For example, the online system determines a count of previously received orders including different items from the item category and associates a count with a corresponding item. In various embodiments, the online system determines a count of previously received orders including a first item within the item category and determines a count of previously received orders including a second item within the item category. Based on counts of the specific type of interaction associated with different items within the item category, the online system selects the set of representative items. In some embodiments, the online system ranks items within the item category based on their corresponding count of the specific type of interaction and selects items having at least a threshold position in the ranking as the set of representative items for the item category.

For each item of the set of representative items, the online system obtains an image. In various embodiments, the online system obtains at least one image for each item of the set of representative items maintained by the online system. However, in other embodiments, the online system transmits a request for an image of an item to a third party system, such as a source from which the item is obtained or a third party system associated with a distributor of the item. In response to receiving the request, the third party system transmits an image of the item to the online system. In some embodiments, the online system obtains a single image for each item of the set of representative items. However, in other embodiments, the online system may obtain any number of images for each item of the set of representative items.

The online system applies a visual language model (VLM) to one or more images of each item of the set of representative items. The VLM comprises a multimodal generative model that receives an image and text data as input. The VLM generates text data based on a received image and text data. In various embodiments, text data generated by the VLM comprises a text description of one or more visual features of an image to which the VLM was applied. For example, the VLM generates sentences or phrases describing one or more visual features of an image to which the VLM is applied. Example visual features of an image include: a description of one or more objects in the image, a description of one or more shapes in the image, a description of one or more colors in the image, text included in the image, relative positioning of objects or shapes in the image, or other descriptive information about the content of the image. As the set of representative items includes items within the item category with which users performed a specific interaction more frequently than with other items within the item category, applying the VLM to the items of the set of representative items identifies visual features of items of the item category with which users are more likely to interact. Hence, the online system generates textual descriptions of each image associated with each item of the set of representative items through application of the VLM to each image associated with an item of the set of representative items in some embodiments.

The online system applies a generative model, such as a large language model (LLM), to the descriptions of visual features for each image to which the VLM was applied to generate an image generation prompt. In various embodiments, the online system retrieves a description of the item category and applies the generative module to a combination of the description of the item category and to the descriptions of visual features of each image associated with an item of the set of representative items. For example, the online system generates a prompt for the generative model including the description of the item category and the descriptions of visual features of each image associated with an item of the set of representative items to which the VLM was applied. In various embodiments the prompt includes one or more formatting instructions affecting display characteristics of an image based on the image generation prompt. Example display characteristics of the image based on the image generation prompt include: a background color of an image based on the image generation prompt, lighting of the image based on the image generation prompt, contrast of the image based on the image generation prompt, or other characteristics affecting presentation of content by an image based on the image generation prompt. In various embodiments, a formatting instruction prevents presentation of one or more specific attributes of an item in an image based on the image generation prompt. For example, one or more formatting instructions prevent presentation of a brand associated with an item in the image based on the image generation prompt, preventing the image based on the image generation prompt from reflecting one or more specific brands.

The image generation prompt comprises text describing one or more visual features of an image. The visual features described by the image generation prompt are based on the one or more descriptions of visual features of images associated with items of the set of representative items generated by the VLM. Hence, the generative model leverages the visual features of images associated with items of the set of representative items to generate a textual prompt identifying visual features of an image generated by an image generation model in response to the image generation prompt. Determining the visual features described by the image generation prompt from images of items of the set of representative items, the visual features of the image generation prompt reflect visual features of images of items within the item category with which users frequently interacted.

Subsequently, the online system applies the image generation model to the image generation prompt to generate a representative image for the item category. The image generation model is a multimodal generative model configured to receive text data as input and to generate an image based on the received text data. For example, the image generation model is a generative adversarial network that receives a text description including visual features of an image and generates an image based on the received text description. As the image generation prompt comprises text describing visual features of the representative image, content of the image generation prompt determines the visual features displayed by the representative image. For example, the image generation prompt includes text descriptions of objects to be displayed by the image generated by the image generation model, such as text describing positioning of objects included in an image, a background color of the image, or other description of content displayed by the representative image.

In various embodiments, the image generation prompt includes an instruction to exclude one or more attributes from display by the representative image. For example, a formatting instruction in the image generation prompt prevents the representative image from displaying information identifying a manufacturer or a distributor of objects included in the representative image to prevent the representative image from identifying a manufacturer or a distributor of one or more items. Additionally, one or more formatting instructions included in the image generation prompt include display characteristics identifying a background of the representative image, lighting of the representative image, or other characteristics affecting how the representative image displays content.

The visual features included in the image generation prompt specify content displayed by the representative image. This leverages historical interactions by users with items within the item category to discern visual features of images of items with which users frequently interacted, so the visual features of the representative image are based on visual features in images of items within the item category with which users more frequently interacted. Further, formatting instructions included in the image generation prompt further specify display of content by the representative image, such as a background of the representative image or lighting which objects in the representative image are displayed. The online system stores the representative image in association with the item category for subsequent retrieval and presentation to users. In various embodiments, the online system stores the representative image in association with the item category in response to the representative image satisfying one or more criteria and may iteratively modify the representative image to satisfy the one or more criteria before storing the representative image in association with the item category.

Leveraging stored historical interactions with items stored by the online system allows identification of visual features of items within the item category with which users more frequently interacted. This accounts for relevance of different items within the item category to users to limit a number of items for which the online system evaluates images. In addition to reducing computational resources allocated to determining visual features of images of items, limiting identification of visual features to images of items with which users more frequently interacted tailors visual features for generating the representative image to visual features of items more likely to be interacted with by users.

Combining the descriptions of visual features of images associated with items of the set of representative items with one or more formatting instructions for a generative model refines the visual features of the representative image to modify visual features included in the representative image. For example, combining formatting instructions with the descriptions of visual features of images associated with items of the set of representative items prevents display of one or more specific attributes of items by the representative image, while basing visual features of the representative image on visual features of items within the item category with which users more frequently interacted. This enables the online system to generate a representative image of an item category that does not display including specific attributes present in images of items that may bias users towards selection of specific items within the item category. Hence, leveraging stored interactions with items in an item category by users and a combination of multiple machine-learning models (e.g., the VLM, the generative model, and the image generation model) to automatically generate a representative image for the item category generates a representative image of an item category including visual features of items within the item category with which users frequently performed one or more specific interactions, while limiting attributes of items present in images that are displayed by the representative image.

### BRIEF DESCRIPTION OF THE DRAWINGS

FIG. 1 illustrates an example system environment for an online system, in accordance with one or more embodiments.

FIG. 2 illustrates an example system architecture for an online system, in accordance with one or more embodiments.

FIG. 3 illustrates a flowchart of a method for generating a representative image for an item category including one or more items accessible via an online system, in accordance with one or more embodiments.

FIG. 4 illustrates a process flow diagram of a method for generating a representative image for an item category including one or more items accessible via an online system, in accordance with one or more embodiments.

### DETAILED DESCRIPTION

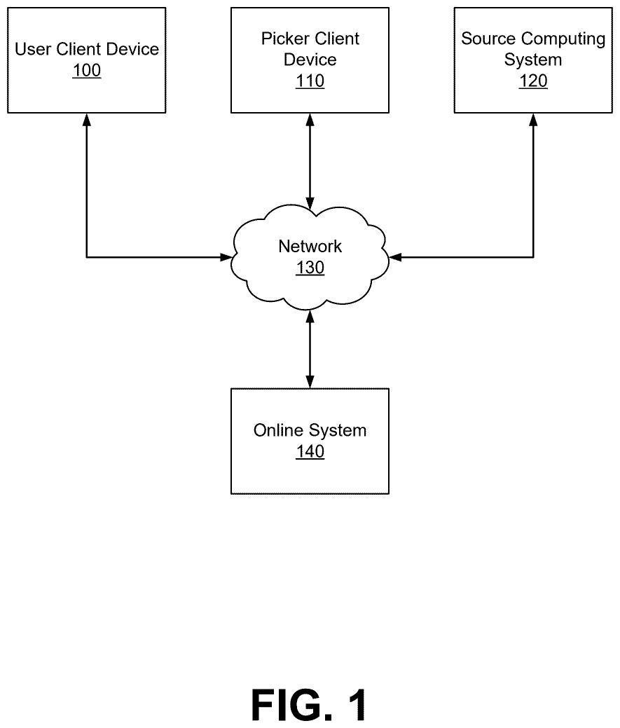

FIG. 1 illustrates an example system environment for an online system 140, in accordance with one or more embodiments. The system environment illustrated in FIG. 1 includes a user client device 100, a picker client device 110, a source computing system 120, a network 130, and an online system 140. Alternative embodiments may include more, fewer, or different components from those illustrated in FIG. 1, and the functionality of each component may be divided between the components differently from the description below. Additionally, each component may perform their respective functionalities in response to a request from a human, or automatically without human intervention.

Although one user client device 100, picker client device 110, and source computing system 120 are illustrated in FIG. 1, any number of users, pickers, and sources may interact with the online system 140. As such, there may be more than one user client device 100, picker client device 110, or source computing system 120.

The user client device 100 is a client device through which a user may interact with the picker client device 110, the source computing system 120, or the online system 140. The user client device 100 can be a personal or mobile computing device, such as a smartphone, a tablet, a laptop computer, or desktop computer. In some embodiments, the user client device 100 executes a client application that uses an application programming interface (API) to communicate with the online system 140.

A user uses the user client device 100 to place an order with the online system 140. An order specifies a set of items to be delivered to the user. An “item,” as used herein, means a good or product that can be provided to the user through the online system 140. The order may include item identifiers (e.g., a stock keeping unit (SKU) or a price look-up (PLU) code) for items to be delivered to the user and may include quantities of the items to be delivered. Additionally, an order may further include a delivery location to which the ordered items are to be delivered and a timeframe during which the items should be delivered. In some embodiments, the order also specifies one or more sources from which the ordered items should be collected.

The user client device 100 presents an ordering interface to the user. The ordering interface is a user interface that the user can use to place an order with the online system 140. The ordering interface may be part of a client application operating on the user client device 100. The ordering interface allows the user to search for items that are available through the online system 140 and the user can select which items to add to an “ordering list.” A “ordering list,” as used herein, is a tentative set of items that the user has selected for an order but that has not yet been finalized for an order. The ordering list may alternatively be referred to as a “cart” or “shopping cart.” The ordering interface allows a user to update the ordering list, e.g., by changing the quantity of items, adding or removing items, or adding instructions for items that specify how the item should be collected.

The user client device 100 may receive additional content from the online system 140 to present to a user. For example, the user client device 100 may receive coupons, recipes, or item suggestions. The user client device 100 may present the received additional content to the user as the user uses the user client device 100 to place an order (e.g., as part of the ordering interface).

Additionally, the user client device 100 includes a communication interface that allows the user to communicate with a picker that is servicing the user's order. This communication interface allows the user to input a text-based message to transmit to the picker client device 110 via the network 130. The picker client device 110 receives the message from the user client device 100 and presents the message to the picker. The picker client device 110 also includes a communication interface that allows the picker to communicate with the user. The picker client device 110 transmits a message provided by the picker to the user client device 100 via the network 130. In some embodiments, messages sent between the user client device 100 and the picker client device 110 are transmitted through the online system 140. In addition to text messages, the communication interfaces of the user client device 100 and the picker client device 110 may allow the user and the picker to communicate through audio or video communications, such as a phone call, a voice-over-IP call, or a video call.

The picker client device 110 is a client device through which a picker may interact with the user client device 100, the source computing system 120, or the online system 140. The picker client device 110 can be a personal or mobile computing device, such as a smartphone, a tablet, a laptop computer, or a desktop computer. In some embodiments, the picker client device 110 executes a client application that uses an application programming interface (API) to communicate with the online system 140.

The picker client device 110 receives orders from the online system 140 for the picker to service. A picker services an order by collecting the items listed in the order from a source. The picker client device 110 presents the items that are included in the user's order to the picker in a collection interface. The collection interface is a user interface that provides information to the picker on which items to collect for a user's order and the quantities of the items. In some embodiments, the collection interface provides multiple orders from multiple users for the picker to service at the same time from the same source location. The collection interface further presents instructions that the user may have included related to the collection of items in the order. Additionally, the collection interface may present a location of each item at the source, and may even specify a sequence in which the picker should collect the items for improved efficiency in collecting items. In some embodiments, the picker client device 110 transmits to the online system 140 or the user client device 100 which items the picker has collected in real time as the picker collects the items.

The picker can use the picker client device 110 to keep track of the items that the picker has collected to ensure that the picker collects all the items for an order. The picker client device 110 may include a barcode scanner that can decode an item identifier encoded in a machine-readable label (e.g., a barcode or a QR code) coupled to an item. The picker client device 110 compares this item identifier to items in the order that the picker is servicing, and if the item identifier corresponds to an item in the order, the picker client device 110 identifies the item as collected. In some embodiments, rather than or in addition to using a barcode scanner, the picker client device 110 captures one or more images of the item and identifies the item identifier for the item based on the images. The picker client device 110 may determine the item identifier directly or by transmitting the images to the online system 140. Furthermore, the picker client device 110 determines weights for items that are priced by weight. The picker client device 110 may prompt the picker to manually input the weight of an item or may communicate with a weighing system in the source location to receive the weight of an item.

When the picker has collected the items for an order, the picker client device 110 instructs a picker on where to deliver the items for a user's order. For example, the picker client device 110 displays a delivery location from the order to the picker. The picker client device 110 also provides navigation instructions for the picker to travel from the source location to the delivery location. When a picker is servicing more than one order, the picker client device 110 identifies which items should be delivered to which delivery location. The picker client device 110 may provide navigation instructions from the source location to each of the delivery locations. The picker client device 110 may receive one or more delivery locations from the online system 140 and may provide the delivery locations to the picker so that the picker can deliver the corresponding one or more orders to those locations. The picker client device 110 may also provide navigation instructions for the picker from the source location from which the picker collected the items to the one or more delivery locations.

In some embodiments, the picker client device 110 tracks the location of the picker as the picker delivers orders to delivery locations. The picker client device 110 collects location data and transmits the location data to the online system 140. The online system 140 may transmit the location data to the user client device 100 for display to the user, so that the user can keep track of when their order will be delivered. Additionally, the online system 140 may generate updated navigation instructions for the picker based on the picker's location. For example, if the picker takes a wrong turn while traveling to a delivery location, the online system 140 determines the picker's updated location based on location data from the picker client device 110 and generates updated navigation instructions for the picker based on the updated location.

In some embodiments, the picker is a single person who collects items for an order from a source location and delivers the order to the delivery location for the order. Alternatively, more than one person may serve the role of a picker for an order. For example, multiple people may collect the items at the source location for a single order. Similarly, the person who delivers an order to its delivery location may be different from the person or people who collected the items from the source location. In these embodiments, each person may have a picker client device 110 that they can use to interact with the online system 140.

Additionally, while the description herein may primarily refer to pickers as humans, in some embodiments, some or all of the steps taken by the picker may be automated. For example, a semi-or fully-autonomous robot may collect items in a source location for an order and an autonomous vehicle may deliver an order to a user from a source location.

In one or more embodiments, the online system 140 communicates with a smart shopping cart being used by a user to collect items in a source location. For example, the smart shopping cart may display content received from the online system and may receive data describing items that are collected by the user and stored in a storage area of the shopping cart. In some embodiments, the smart shopping cart is a picker client device 110 being operated by a picker collecting items within a source location. Similarly, the smart shopping cart may be operated by a user within the source location collecting items for themselves. Example embodiments of smart shopping carts are described in U.S. patent application Ser. No. 18/630,672, entitled “Automated Identification of Items Placed in a Cart and Recommendations based on Same,” filed Apr. 9, 2024, which is hereby incorporated by reference in its entirety.

The source computing system 120 is a computing system operated by a source that interacts with the online system 140. As used herein, a “source” is an entity that operates a “source location,” which is a store, warehouse, or any other source from which a picker can collect items. The source computing system 120 stores and provides item data to the online system 140 and may regularly update the online system 140 with updated item data. For example, the source computing system 120 provides item data indicating which items are available at a particular source location and the quantities of those items. Additionally, the source computing system 120 may transmit updated item data to the online system 140 when an item is no longer available at the source location. Additionally, the source computing system 120 may provide the online system 140 with updated item prices, sales, or availabilities. Additionally, the source computing system 120 may receive payment information from the online system 140 for orders serviced by the online system 140. Alternatively, the source computing system 120 may provide payment to the online system 140 for some portion of the overall cost of a user's order (e.g., as a commission).

The user client device 100, the picker client device 110, the source computing system 120, and the online system 140 can communicate with each other via the network 130. The network 130 is a collection of computing devices that communicate via wired or wireless connections. The network 130 may include one or more local area networks (LANs) or one or more wide area networks (WANs). The network 130, as referred to herein, is an inclusive term that may refer to any or all of the standard layers used to describe a physical or virtual network, such as the physical layer, the data link layer, the network layer, the transport layer, the session layer, the presentation layer, and the application layer. The network 130 may include physical media for communicating data from one computing device to another computing device, such as multiprotocol label switching (MPLS) lines, fiber optic cables, cellular connections (e.g., 3G, 4G, or 5G spectra), or satellites. The network 130 also may use networking protocols, such as TCP/IP, HTTP, SSH, SMS, or FTP, to transmit data between computing devices. In some embodiments, the network 130 may include Bluetooth or near-field communication (NFC) technologies or protocols for local communications between computing devices. The network 130 may transmit encrypted or unencrypted data.

The online system 140 is an online system by which users can order items to be provided to them by a picker from a source. The online system 140 receives orders from a user client device 100 through the network 130. The online system 140 selects a picker to service the user's order and transmits the order to a picker client device 110 associated with the picker. If the picker accepts the order, the picker collects the ordered items from a source location and delivers the ordered items to the user. The online system 140 may charge a user for the order and provide portions of the payment from the user to the picker and the source.

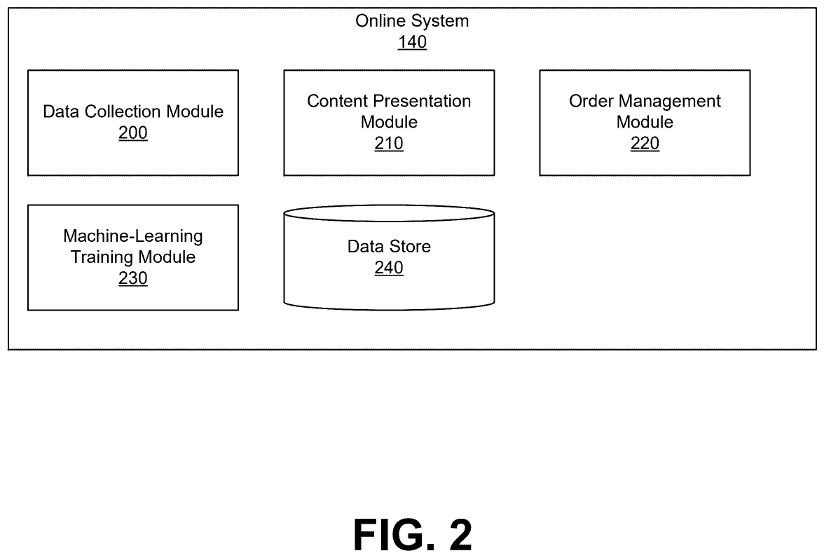

As an example, the online system 140 may allow a user to order groceries from a grocery store source. The user's order may specify which groceries they want to be delivered from the grocery store and the quantities of each of the groceries. The user's client device 100 transmits the user's order to the online system 140 and the online system 140 selects a picker to travel to the grocery store source location to collect the groceries ordered by the user. The online system transmits an offer to the picker for the picker to service the order in exchange for consideration and, if the picker accepts the offer, the picker collects the groceries from the grocery store. Once the picker has collected the groceries ordered by the user, the picker delivers the groceries to a location transmitted to the picker client device 110 by the online system 140. The online system 140 is described in further detail below with regards to FIG. 2.

FIG. 2 illustrates an example system architecture for an online system 140, in accordance with some embodiments. The system architecture illustrated in FIG. 2 includes a data collection module 200, a content presentation module 210, an order management module 220, a machine-learning training module 230, and a data store 240. Alternative embodiments may include more, fewer, or different components from those illustrated in FIG. 2, and the functionality of each component may be divided between the components differently from the description below. Additionally, each component may perform their respective functionalities in response to a request from a human, or automatically without human intervention.

The data collection module 200 collects data used by the online system 140 and stores the data in the data store 240. In preferred embodiments, the data collection module 200 only collects data describing a user if the user has previously explicitly consented to the online system 140 collecting data describing the user. Additionally, the data collection module 200 may encrypt all data, including sensitive or personal data, describing users.

For example, the data collection module 200 collects user data, which is information or data that describe characteristics of a user. User data may include a user's name, address, shopping preferences, favorite items, or stored payment instruments. The user data also may include default settings established by the user, such as a default source/source location, payment instrument, delivery location, or delivery timeframe. The data collection module 200 may collect the user data from sensors on the user client device 100 or based on the user's interactions with the online system 140.

The data collection module 200 also collects item data, which is information or data that identifies and describes items that are available at a source location. The item data may include item identifiers for items that are available and may include quantities of items associated with each item identifier. Additionally, item data may also include attributes of items such as the size, color, weight, stock keeping unit (SKU), or serial number for the item. The item data may further include purchasing rules associated with each item, if they exist. For example, age-restricted items such as alcohol and tobacco are flagged accordingly in the item data. Item data may also include information that is useful for predicting the availability of items in source locations. For example, for each item-source combination (a particular item at a particular warehouse), the item data may include a time that the item was last found, a time that the item was last not found (a picker looked for the item but could not find it), the rate at which the item is found, or the popularity of the item. The data collection module 200 may collect item data from a source computing system 120, a picker client device 110, or the user client device 100.

An item category is a set of items that are a similar type of item. Items in an item category may be considered to be equivalent to each other or may be replacements for each other in an order. For example, different brands of sourdough bread may be different items, but these items may be in a “sourdough bread” item category. The item categories may be human-generated and human-populated with items. The item categories also may be generated automatically by the online system 140 (e.g., using a clustering algorithm).

The data collection module 200 also collects picker data, which is information or data that describes characteristics of pickers. For example, the picker data for a picker may include the picker's name, the picker's location, how often the picker has serviced orders for the online system 140, a user rating for the picker, which sources the picker has collected items at, or the picker's previous shopping history. Additionally, the picker data may include preferences expressed by the picker, such as their preferred sources to collect items at, how far they are willing to travel to deliver items to a user, how many items they are willing to collect at a time, timeframes within which the picker is willing to service orders, or payment information by which the picker is to be paid for servicing orders (e.g., a bank account). The data collection module 200 collects picker data from sensors of the picker client device 110 or from the picker's interactions with the online system 140.

Additionally, the data collection module 200 collects order data, which is information or data that describes characteristics of an order. For example, order data may include item data for items that are included in the order, a delivery location for the order, a user associated with the order, a source location from which the user wants the ordered items collected, or a timeframe within which the user wants the order delivered. Order data may further include information describing how the order was serviced, such as which picker serviced the order, when the order was delivered, or a rating that the user gave the delivery of the order. In some embodiments, the order data includes user data for users associated with the order, such as user data for a user who placed the order or picker data for a picker who serviced the order.

While user data, picker data, source data, item data, and order data are described separately, data collected by the data collection module 200 may fall into more than one of these categories. For example, data describing a picker's performance for an order may be order data and picker data.

The content presentation module 210 selects content for presentation to a user. For example, the content presentation module 210 selects which items to present to a user while the user is placing an order. The content presentation module 210 generates and transmits an ordering interface for the user to order items. The content presentation module 210 populates the ordering interface with items that the user may select for adding to their order. In some embodiments, the content presentation module 210 presents a catalog of all items that are available to the user, which the user can browse to select items to order. The content presentation module 210 also may identify items that the user is most likely to order and present those items to the user. For example, the content presentation module 210 may score items and rank the items based on their scores. The content presentation module 210 displays the items with scores that exceed some threshold (e.g., the top n items or the p percentile of items).

The content presentation module 210 may use an item selection model to score items for presentation to a user. An item selection model is a machine-learning model that is trained to score items for a user based on item data for the items and user data for the user. For example, the item selection model may be trained to determine a likelihood that the user will order the item. In some embodiments, the item selection model uses item embeddings describing items and user embeddings describing users to score items. These item embeddings and user embeddings may be generated by separate machine-learning models and may be stored in the data store 240.

In some embodiments, the content presentation module 210 scores items based on a search query received from the user client device 100. A search query is free text for a word or set of words that indicate items of interest to the user. The content presentation module 210 scores items based on a relatedness of the items to the search query. For example, the content presentation module 210 may apply natural language processing (NLP) techniques to the text in the search query to generate a search query representation (e.g., an embedding) that represents characteristics of the search query. The content presentation module 210 may use the search query representation to score candidate items for presentation to a user (e.g., by comparing a search query embedding to an item embedding).

In some embodiments, the content presentation module 210 scores items based on a predicted availability of an item. The content presentation module 210 may use an availability model to predict the availability of an item. An availability model is a machine-learning model that is trained to predict the availability of an item at a particular source location. For example, the availability model may be trained to predict a likelihood that an item is available at a source location or may predict an estimated number of items that are available at a source location. The content presentation module 210 may apply a weight to the score for an item based on the predicted availability of the item. Alternatively, the content presentation module 210 may filter out items from presentation to a user based on whether the predicted availability of the item exceeds a threshold.

In various embodiments, the content presentation module 210 displays descriptions of one or more item categories to a user. As further described above, an item category is a set of items that are a similar type of item. For example, an ordering interface displays descriptions of one or more item categories to a user, allowing the user to select an item category to be presented with items within the item category. Presenting descriptions of one or more item categories provides users with a mechanism for identifying different items available for inclusion in an order.

To simplify identification of different item categories, the content management module 210 generates a representative image for each of at least a set of item categories. In various embodiments, the content presentation module 210 displays a representative image of an item category as at least a portion of a description of the item category. For example, the content presentation module 210 displays a text name of an item category and a representative image of the item category. Alternatively, the content presentation module 210 displays the representative image of an item category to identify the item category to the user.

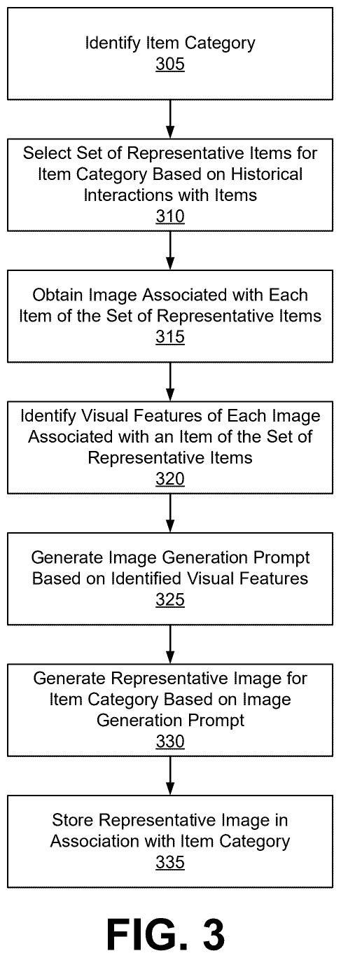

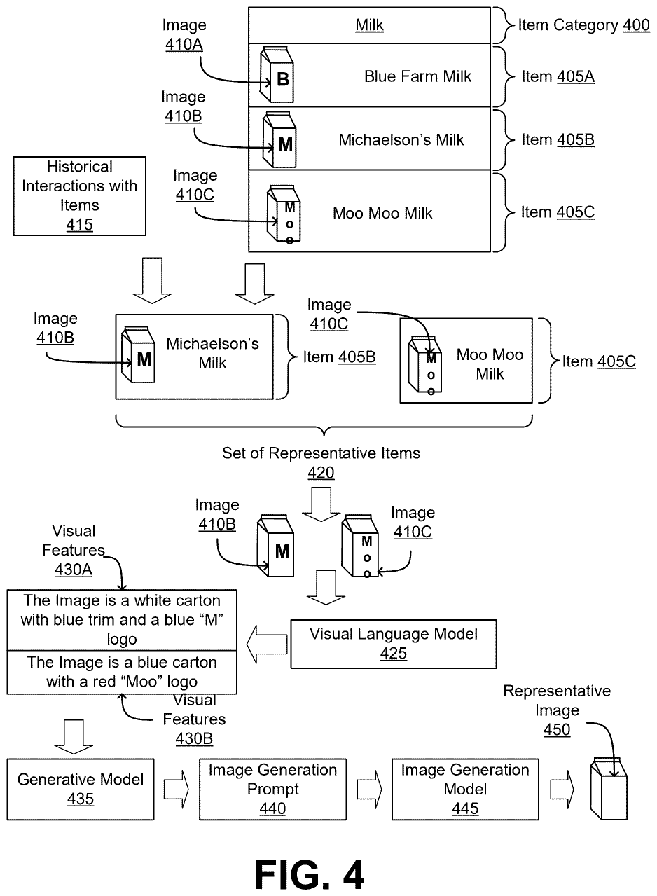

As further described below in conjunction with FIGS. 3 and 4, the content presentation module 210 leverages historical interactions by users with items within an item category to generate a representative image for the item category. In various embodiments, the content presentation module 210 selects a set of representative items for the item category based on historical interactions with the items within the item category. The content presentation module 210 obtains at least one image of each item of the set of representative items and applies a visual language model (VLM) to each image of an item of the set of representative items. Application of the VLM generates a text description of visual features within an image, so the content presentation module 210 generates text descriptions of each image of an item of the set of representative items.

Based on the text descriptions of each image of an item of the set of representative items, the content presentation module 210 generates an image generation prompt. In various embodiments, the content presentation module 210 applies a generative model, such as a large language model (LLM), to a prompt including the text descriptions of each image of an item of the set of representative items to generate the image generation prompt, as further described below in conjunction with FIGS. 3 and 4. The prompt may include formatting instructions or a description of the item category in some embodiments. The image generation prompt comprises text describing visual features for an image that are based on visual features included in the text descriptions of each image of an item of the set of representative items. As further described below in conjunction with FIGS. 3 and 4, the content presentation module applies an image generation model to the image generation prompt, with the image generation model generating a representative image for the item category based on the visual features described in the image generation prompt. Further, the image generation prompt may include one or more formatting instructions that regulate attributes of items within the item category that are displayed by the representative image for the item category.

The order management module 220 manages orders for items from users. The order management module 220 receives orders from a user client device 100 and offers the orders to pickers for service based on picker data. For example, the order management module 220 offers an order to a picker based on the picker's location and the location of the source from which the ordered items are to be collected. The order management module 220 may also offer an order to a picker based on how many items are in the order, a vehicle operated by the picker, the delivery location, the picker's preferences on how far to travel to deliver an order, the picker's ratings by users, or how often a picker agrees to service an order.

In some embodiments, the order management module 220 determines when to offer an order to a picker based on a delivery timeframe requested by the user with the order. The order management module 220 computes an estimated amount of time that it would take for a picker to collect the items for an order and deliver the ordered items to the delivery location for the order. The order management module 220 offers the order to a picker at a time such that, if the picker immediately accepts and services the order, the picker is likely to deliver the order at a time within the requested timeframe. Thus, when the order management module 220 receives an order, the order management module 220 may delay offering the order to a picker if the requested timeframe is far enough in the future (i.e., the picker may be offered the order at a later time and is still predicted to meet the requested timeframe).

When the order management module 220 offers an order to a picker, the order management module 220 transmits the order to the picker client device 110 associated with the picker. The order management module 220 may also transmit navigation instructions from the picker's current location to the source location associated with the order. If the order includes items to collect from multiple source locations, the order management module 220 identifies the source locations to the picker and may also specify a sequence in which the picker should visit the source locations.

The order management module 220 may track the location of the picker through the picker client device 110 to determine when the picker arrives at the source location. When the picker arrives at the source location, the order management module 220 transmits the order to the picker client device 110 for display to the picker. As the picker uses the picker client device 110 to collect items at the source location, the order management module 220 receives item identifiers for items that the picker has collected for the order. In some embodiments, the order management module 220 receives images of items from the picker client device 110 and applies computer-vision techniques to the images to identify the items depicted by the images. The order management module 220 may track the progress of the picker as the picker collects items for an order and may transmit progress updates to the user client device 100 that describe which items have been collected for the user's order.

In some embodiments, the order management module 220 tracks the location of the picker within the source location. The order management module 220 uses sensor data from the picker client device 110 or from sensors in the source location to determine the location of the picker in the source location. The order management module 220 may transmit, to the picker client device 110, instructions to display a map of the source location indicating where in the source location the picker is located. Additionally, the order management module 220 may instruct the picker client device 110 to display the locations of items for the picker to collect, and may further display navigation instructions for how the picker can travel from their current location to the location of the next item to collect for an order.

The order management module 220 determines when the picker has collected the items for an order. For example, the order management module 220 may receive a message from the picker client device 110 indicating that all of the items for an order have been collected. Alternatively, the order management module 220 may receive item identifiers for items collected by the picker and determine when all of the items in an order have been collected. When the order management module 220 determines that the picker has completed an order, the order management module 220 transmits the delivery location for the order to the picker client device 110. The order management module 220 may also transmit navigation instructions to the picker client device 110 that specify how to travel from the source location to the delivery location, or to a subsequent source location for further item collection. The order management module 220 tracks the location of the picker as the picker travels to the delivery location for an order, and updates the user with the location of the picker so that the user can track the progress of the order. In some embodiments, the order management module 220 computes an estimated time of arrival of the picker at the delivery location and provides the estimated time of arrival to the user.

In some embodiments, the order management module 220 facilitates communication between the user client device 100 and the picker client device 110. As noted above, a user may use a user client device 100 to send a message to the picker client device 110. The order management module 220 receives the message from the user client device 100 and transmits the message to the picker client device 110 for presentation to the picker. The picker may use the picker client device 110 to send a message to the user client device 100 in a similar manner.

The order management module 220 coordinates payment by the user for the order. The order management module 220 uses payment information provided by the user (e.g., a credit card number or a bank account) to receive payment for the order. In some embodiments, the order management module 220 stores the payment information for use in subsequent orders by the user. The order management module 220 computes the total cost for the order and charges the user that cost. The order management module 220 may provide a portion of the total cost to the picker for servicing the order, and another portion of the total cost to the source.

The machine-learning training module 230 trains machine-learning models used by the online system 140. The online system 140 may use machine-learning models to perform functionalities described herein. Example machine-learning models include regression models, support vector machines, naïve Bayes, decision trees, k nearest neighbors, random forest, boosting algorithms, k-means, and hierarchical clustering. The machine-learning models may also include neural networks, such as perceptrons, multilayer perceptrons, convolutional neural networks, recurrent neural networks, sequence-to-sequence models, generative adversarial networks, transformers, large-language models, or multi-modal large language models. A machine-learning model may include components relating to these different general categories of model, which may be sequenced, layered, or otherwise combined in various configurations. While the term “machine-learning model” may be broadly used herein to refer to any kind of machine-learning model, the term is generally limited to those types of models that are suitable for performing the described functionality. For example, certain types of machine-learning models can perform a particular functionality based on the intended inputs to, and outputs from, the model, the capabilities of the system on which the machine-learning model will operate, or the type and availability of training data for the model.

Each machine-learning model includes a set of parameters. The set of parameters for a machine-learning model are parameters that the machine-learning model uses to process an input to generate an output. For example, a set of parameters for a linear regression model may include weights that are applied to each input variable in the linear combination that comprises the linear regression model. Similarly, the set of parameters for a neural network may include weights and biases that are applied at each neuron in the neural network. The machine-learning training module 230 generates the set of parameters (e.g., the particular values of the parameters) for a machine-learning model by “training” the machine-learning model. Once trained, the machine-learning model uses the set of parameters to transform inputs into outputs.

The machine-learning training module 230 trains a machine-learning model based on a set of training examples. Each training example includes input data to which the machine-learning model is applied to generate an output. For example, each training example may include user data, picker data, item data, or order data. In some cases, the training examples also include a label which represents an expected output of the machine-learning model. In these cases, the machine-learning model is trained by comparing its output from the input data of a training example to the label for the training example. In general, during training with labeled data, the set of parameters of the model may be set or adjusted to reduce a difference between the output for the training example (given the current parameters of the model) and the label for the training example.

The machine-learning training module 230 may apply an iterative process to train a machine-learning model whereby the machine-learning training module 230 updates parameter values of the machine-learning model based on each of the set of training examples. The training examples may be processed together, individually, or in batches. To train a machine-learning model based on a training example, the machine-learning training module 230 applies the machine-learning model to the input data in the training example to generate an output based on a current set of parameter values. The machine-learning training module 230 scores the output from the machine-learning model using a loss function. A loss function is a function that generates a score for the output of the machine-learning model such that the score is higher when the machine-learning model performs poorly and lower when the machine-learning model performs well. In cases where the training example includes a label, the loss function is also based on the label for the training example. Some example loss functions include the mean square error function, the mean absolute error, hinge loss function, and the cross entropy loss function. The machine-learning training module 230 updates the set of parameters for the machine-learning model based on the score generated by the loss function. For example, the machine-learning training module 230 may apply gradient descent to update the set of parameters.

In some embodiments, the machine-learning training module 230 may retrain the machine-learning model based on the actual performance of the model after the online system 140 has deployed the model to provide service to users. For example, if the machine-learning model is used to predict a likelihood of an outcome of an event, the online system 140 may log the prediction and an observation of the actual outcome of the event. Alternatively, if the machine-learning model is used to classify an object, the online system 140 may log the classification as well as a label indicating a correct classification of the object (e.g., following a human labeler or other inferred indication of the correct classification). After sufficient additional training data has been acquired, the machine-learning training module 230 re-trains the machine-learning model using the additional training data, using any of the methods described above. This deployment and re-training process may be repeated over the lifetime use for the machine-learning model. This way, the machine-learning model continues to improve its output and adapts to changes in the system environment, thereby improving the functionality of the online system 140 as a whole in its performance of the tasks described herein.

In various embodiments, the machine learning training module 230 obtains a visual language model comprising a multimodal generative model that receives an image and text data as input. The visual language model generates an output based on the received image and text data. For example, the visual language model generates text data based on the received image and text data. As another example, the visual language model generates an output image based on the received image and text data. The visual language model is pre-trained on a set of multimodal training data, with the multimodal training data comprising an image and text corresponding to the image. Text corresponding to an image in the multimodal training data may be captions describing the image, labels of objects included in the image, or other descriptive information about the image. In some embodiments, the visual language model is pre-trained to perform one or more specific tasks, such as visual question answering, where the visual language model receives an image and a question about the image and generates an answer to the question based on the image. Pre-training of the visual language model for visual question answering may be performed by applying the visual language model to training examples each including a question and an image, with each training example labeled with an answer corresponding to the question included in the training example.

Additionally, the machine learning training module 230 trains or obtains one or more generative models. A generative model, such as a large language model (LLM), receives an input including a prompt and generates output based on the received input. For example, a generative model is a large language model (LLMs) previously trained on a large text corpus to learn relationships between different portions of text, such as between different words. Based on the previously learned relationships, the LLM generates output text from text received as input based on a prompt received as input. For example, a generative model receives a prompt including one or more formatting instructions and text data as input and generates output text in a format specified by the one or more formatting instructions and based on the input text and previously learned relationships between various texts.

In some embodiments, a generative model is an image generation model pre-trained on a training corpus including pairs of images and text data. For example, each pair includes an image and a text caption or other text describing the image. From the training corpus, the image generation model learns relationships between various text data and various images. The image generation model leverages the learned relationships to generate an image in response to received text input, allowing generation of an image based on received text input.

The data store 240 stores data used by the online system 140. For example, the data store 240 stores user data, item data, order data, and picker data for use by the online system 140. The data store 240 also stores trained machine-learning models trained by the machine-learning training module 230. For example, the data store 240 may store the set of parameters for a trained machine-learning model on one or more non-transitory, computer-readable media. The data store 240 uses computer-readable media to store data, and may use databases to organize the stored data.

FIG. 3 is a flowchart of a method for generating a representative image for an item category including one or more items accessible via an online system 140, in accordance with some embodiments. Alternative embodiments may include more, fewer, or different steps from those illustrated in FIG. 3, and the steps may be performed in a different order from that illustrated in FIG. 3. These steps may be performed by an online system (e.g., online system 140). Additionally, each of these steps may be performed automatically by the online system without human intervention.

An online system 140 maintains information describing various items accessible to the online system 140 from one or more sources. In various embodiments, the online system 140 receives selections of items from a user and obtains one or more specified items for the user. In various embodiments, the online system 140 accesses items from one or more sources, enabling a user to select items available from different sources. Alternatively, one or more items selected by a user are obtained from the online system 140. To simplify retrieval and identification, the online system 140 maintains an item catalog for each source or maintains an item catalog of items accessible via the online system 140. An item catalog identifies items offered by a source and attributes of each item accessible via the online system 140. In various embodiments, the online system 140 organizes an item catalog as a taxonomy having a hierarchical structure. Such a taxonomy has multiple levels, with different levels including different levels of detail about items. For example, a level of the taxonomy comprises an item category including items having one or more common attributes, and a lower level of the taxonomy from the item category identifies individual items within the item category. In other embodiments, the item catalog includes multiple item categories, with each item category including items having one or more common attributes.

In various embodiments, the online system 140 displays different item categories from an item catalog to a user. In response to receiving a selection of an item category from a user, the online system 140 retrieves at least a subset of items included in the selected item category (e.g., items included in a level of a taxonomy that is lower than a level comprising the item category) and displays the retrieved items to the user. This allows the user to select one or more items from the item category for the online system 140 to obtain. For example, the online system 140 receives a selection of an item category from a user, retrieves items from the item catalog included in the item category, and subsequently receives a selection of one or more of the retrieved items from the user for inclusion in an order. Hence, item categories simplify a user browsing items accessible from a source or selecting one or more items accessible from the source.

When presenting one or more item categories to a user, the online system 140 displays information describing an item category to a user. For example, the online system 140 displays a name of the item category. In some embodiments, the online system 140 also displays a description of items included in the item category. The description of items included in the item category may be a text description of one or more attributes common across items included in the item category or may be other information about items included in the item category in various embodiments.

Displaying an image that visually represents one or more items within an item category to a user may reduce an amount of time for the user to select an item category. Similarly, displaying images representing one or more items within different item categories allows a user to more easily differentiate between different item categories presented to the user. A representative image for an item category may be manually created, but manual creation of the representative image is time-and resource-intensive. Additionally, manually creating representative images for different item categories inefficiently scales as a number of item categories increases or as a number of items within item categories increases. While the online system 140 may use stock photographs or images as representative images for item categories, such stock photographs or images may not accurately reflect items included in the item category, which may cause a user to select item categories that do not include items in which the user is interested. This increases an amount of interaction by users with the online system 140 to identify items accessible via the online system 140, decreasing a likelihood of the users subsequently interacting with the online system 140.

While an item catalog includes images of various items in some embodiments, selecting an image of an item from the item catalog as a representative image of an item category including the item can influence subsequent user interaction with the online system 140. For example, selecting an image of a specific item included in an item category as a representative image increases a likelihood of users subsequently selecting the specific item used as the representative image. Further, images of items often identify a brand (such as a manufacturer or a distributor) of the items, so using an image of an item as a representative image may bias users to selecting items included in the item category associated with the brand included in the representative image.

Although the online system 140 has access to images of specific items in an item category, attributes shown in those images may affect subsequent user selection of items. Manual creation of selection of representative images for item categories is impractical and inefficient, while increasing a probability of a representative image inaccurately representing items within the item category. To automate generation of a representative image for an item category that is independent of one or more attributes associated with an item (e.g., a brand associated with an item), the online system 140 identifies 305 an item category, such as an item category of an item catalog. For example, the online system 140 receives a selection of the item catalog from a user, such an administrative user associated with the source for which the item catalog was obtained, and identifies 305 the selected item catalog. As another example, the online system 140 selects a source and automatically identifies 305 an item category from an item catalog maintained for the selected source. For another example, the online system 140 automatically identifies 305 an item category from an item catalog maintained by the online system 140. In some embodiments, the online system 140 identifies 305 each of at least a set of item categories maintained by the online system 140.

For the identified item category, the online system 140 retrieves historical interactions by users of the online system 140 with items within the identified item category. In various embodiments, the data store 240 maintains one or more databases identifying interactions by users with items. For example, a database maintained in the data store 240 includes entries that each correspond to an interaction by a user with an item. In various embodiments, an entry includes an identifier of a user, an identifier of an item, and a description of an interaction by the user with the item. An entry includes a time associated with the interaction by the user with the item in some embodiments.

In various embodiments, the online system 140 retrieves a specific type of interaction by users with items from historical interactions by users with items in the data store 240. For example, the online system 140 identifies the specific type of interaction and retrieves historical interactions that have the specific type and are with an item within the identified item category. From the retrieved interactions having the specific type, the online system 140 determines a count of the specific type of interaction performed by users for each of at least a set of items within the identified item category. Determining a count of the specific type of interaction by users with different items within the identified item category provides an indication of a frequency with which users interact with different items within the item category, providing a metric showing relative popularity of different items within the item category to users.

In some embodiments, the online system 140 identifies interactions having the specific type with an item within the identified item category and associated with a source for which the identified item category was maintained. Accounting for a source for which the identified item category was maintained allows the online system 140 to account for potential variations between types of interactions by users with items accessible from different sources. For example, the online system 140 identifies a source associated with the item category and retrieves a subset of historical interactions by users with items that are each associated with the source. Based on the subset of historical interactions associated with the source, the online system 140 determines a count of a type of specific interaction by users with different items in the item category, providing a source-specific count of the specific type of interaction with different items within the item category.

The online system 140 selects 310 a set of representative items based on the count of the specific type of interaction maintained for different items within the identified item category. In some embodiments, the online system 140 ranks the items within the identified item category based on their corresponding counts and selects 310 items having at least the threshold position in the ranking as the set of representative items. For example, the online system 140 ranks the items within the item category based on a number of times the online system 140 received requests from users for information about different items or based on a number of times the online system 140 received requests from users to save different items in lists associated with one or more users. The online system 140 may retrieve interactions by users with items within the item category occurring within a specific time interval and determine counts of the specific interaction by users with the items within the item category occurring during the specific time interval. Further, in some embodiments, the online system 140 determines the count of the specific interaction based on performance of the specific interaction by users having one or more specific characteristics, such as users associated with a specific location by the online system 140.

For example, the online system 140 retrieves prior orders received from users that included at least one item from the identified item category. For an item in the identified item category, the online system 140 determines a number of prior orders including the item. The online system 140 determines the number of prior orders including different items within the item category in various embodiments. In various embodiments, the online system 140 maintains a count of orders for each of at least a set of items within the item category. Based on the counts maintained for various items within the item category, the online system 140 selects 310 a set of representative items for the item category. For example, the online system 140 ranks items within the item category based on their associated counts of selected orders and selects 310 items having at least a threshold position in the ranking as the set of representative items. As another example, the online system 140 selects items having at least a threshold count as the set of representative items.

For each item of the set of representative items, the online system 140 obtains 315 one or more images. In various embodiments, the online system 140 retrieves one or more images of an item of the set of representative items. Alternatively, the online system 140 identifies an item to a source from which the item is obtained and obtains 315 one or more images of the item from the source. In various embodiments, the online system 140 obtains 315 a single image for each item of the set of representative items. However, in other embodiments, the online system 140 obtains 315 multiple images of each item of the set of representative items. The online system 140 obtains 315 at least a threshold number of images for each item of the set of representative items in some embodiments.

The online system 140 applies a visual language model (VLM) to an image of an item of the set of representative items to identify 320 visual features of the image. In various embodiments, the online system 140 applies the VLM to each image of each item of the set of representative items to identify 320 visual features of each of the images of items of the set of representative items. The VLM comprises a multimodal generative model that receives an image and text data as input and that generates an output, such as text data, based on the received image and text data. In various embodiments, the VLM generates a text description identifying 320 one or more visual features of an image to which the VLM was applied. For example, the VLM generates sentences or phrases describing one or more visual features of an image to which the VLM is applied. Example visual features of an image include: a description of one or more objects in the image, a description of one or more shapes in the image, a description of one or more colors in the image, text included in the image, relative positioning of objects or shapes in the image, or other descriptive information about the content of the image.

The VLM is pre-trained on a set of multimodal training data, with the multimodal training data comprising various combinations of a training image and text corresponding to the training image. Different training images and corresponding text are included in the multimodal training data. In some embodiments, the VLM is pre-trained to perform one or more specific tasks, such as visual question answering, where the VLM receives an image and a question about the image as input and generates a text answer to the question based on the image. For example, the online system 140 applies a VLM to the image and to a prompt requesting the VLM identify one or more visual features of the image. As another example, the online system 140 applies a VLM to the image and to a prompt requesting the VLM identify text included in the image. The prompt may specify that the VLM generate different groups of visual features and may specify a format in which the output of the VLM describes visual features of the image. In various embodiments, the online system 140 applies the VLM to combinations of an image and different prompts to identify 320 different visual features of the image. Further, in various embodiments, the online system 140 applies multiple VLMs to the image to identify 320 different visual features from an image.

The online system 140 stores visual features identified 320 from an image of an item of the set of representative items in association with an identifier of the item. In some embodiments, the online system 140 stores visual features identified 320 from the image of the item in association with an identifier of the item and in association with the image of the item. The online system 140 identifies 320 and stores visual features from each of the images obtained 315 for items of the set of representative items in various embodiments.

Based on the visual features identified 320 from one or more images of one or more items of the set of representative items for the image category, the online system 140 generates 325 an image generation prompt. In some embodiments, the online system 140 generates 325 the image generation prompt based on the identified visual features from one or more images of one or more items of the set of representative items and a maintained description of the item category. The description of an item category may be a name of the item category in some embodiments or may be a name of the item category and text identifying attributes or items in the item category in other embodiments. To automate generation 325 of the image generation prompt, the online system 140 applies a generative model to the visual features of images of items of the set of representative items of the item category (and to the description of the item category in some embodiments). For example, the generative model is a large language model (LLM) configured to receive text data as input and to generate text data comprising the image generation prompt for the image generation model as an output.

In various embodiments, the online system 140 creates a prompt for the generative model including visual features identified 320 for one or more images of one or more items of the set of representative items. The prompt also includes the description of the item category in various embodiments. Additionally, in some embodiments, the prompt includes one or more formatting instructions affecting display of an image based on the image generation prompt. For example, formatting instructions specify a background color of an image based on the image generation prompt, lighting of the image based on the image generation prompt, contrast of the image based on the image generation prompt, or other attributes affecting presentation of content in an image. Further, one or more formatting instructions specify attributes of items to exclude from an image. For example, a formatting instruction specifies the image withhold display of a manufacturer of an item, withhold display of a distributor of an item, or withhold display of a brand associated with an item. The generative model receives the prompt as input and generates the image generation prompt based on the visual features of images of the representative items of the item category (as well as one or more formatting instructions or the description of the item category in various embodiments).

The image generation prompt describes visual features to be presented in an image. Providing the visual features identified 320 from images of items of the set of representative items to the generative model causes the image generation prompt to account for visual features of images of representative items when determining visual features to include in a generated image. As items of the set of representative items are representative of items of the item category with which users more frequently perform a specific interaction, visual features from images of items of the representative set are more likely to be relevant to users. Having the

The online system 140 generates 330 a representative image for the item category by applying a trained image generation model to the image generation prompt. The image generation model is a multimodal generative model configured to receive text data as input and to generate an image based on the text input. For example, the image generation model is a generative adversarial network that receives a text description of visual features of an image and generates an image including at least a subset of the described visual features. The image generation prompt textually describes visual features of content included in the representative image. For example, the image generation prompt includes text descriptions of one or more objects comprising the representative image, such as text describing positioning of objects comprising the representative image, a background color of the image, or other description of content presented by the representative image.

One or more formatting instructions included in the image generation prompt also regulate attributes of items that are presented by the representative image. In various embodiments, the image generation prompt includes an instruction identifying one or more attributes of items that are excluded from display by the representative image. For example, the image generation prompt includes an instruction to exclude information identifying a manufacturer or a distributor of one or more items within the item category from presentation in the representative image. Such a formatting instruction prevents the representative image from identifying a manufacturer or a distributor of one or more items. Other attributes of items may be identified by a formatting instruction to be excluded from presentation by the representative image. Hence, the image generation prompt identifies visual features to display in the representative image based on visual features of images of representative items, and allows one or more attributes of items to be prevented from presentation by the representative image.

The online system 140 stores 335 the representative image in association with the identified item category for subsequent retrieval. For example, the online system 140 stores the representative image as a portion of the description of the identified item category. As another example, the online system 140 stores the representative image as additional data associated with the identified item category.

In some embodiments, the online system 140 evaluates the representative image and stores 335 the representative image in association with the item category in response to the representative image satisfying one or more criteria. For example, the online system 140 applies the VLM to the representative image, generating a description of visual features of the representative image, as further described above. The online system 140 compares the description of visual features of the representative image to the image generation prompt to identify discrepancies between visual features of the representative image and visual features specified by the image generation prompt. For example, the online system 140 determines a percentage of visual features specified by the image generation prompt included in the description of visual features of the representative image and stores 335 the representative image in response to the percentage equaling or exceeding a threshold percentage.

In some embodiments, in response to determining the percentage of visual features specified by the image generation prompt included in the description of visual features of the representative image is less than the threshold percentage, the online system 140 modifies the representative image. For example, the online system 140 generates an image modification prompt including the description of visual features of the representative image and including visual features from the image generation prompt that are not included in the image generation prompt. The online system 140 applies the image generation model to the image modification prompt to generate a modified representative image. In various embodiments, the online system stores 335 the modified representative images in association with the image category. Further, the online system 140 may iteratively modify a generated representative image until the modified representative image satisfies the one or more criteria, then store 335 the modified representative image in association with the item category.

With the representative image stored 330 is associated with the item category, the online system 140 may subsequently display the representative image to one or more users to simplify identification of the item category. For example, in response to receiving a request identifying the item category from a user, the online system 140 displays the representative image associated with the item category. As an example, the request comprises a search query received from a user that at least partially matches a name or a description of the item category, so the online system 140 displays the representative image associated with the item category to the user. In another example, the online system 140 receives a selection of a source associated with the item catalog including the item category. In response to the selection of the source, the online system 140 displays at least a subset of item categories associated with the source, with the online system 140 displaying a representative image associated with the item category of the subset. This allows the user to more easily identify different item categories offered by a source and to select an item category. As another example, the online system 140 receives a request from a user for items accessible to the online system 140, and the online system 140 retrieves a set of item categories corresponding to items accessible to the online system 140. The online system 140 displays representative images associated with one or more item categories of the set of item categories in various embodiments.

FIG. 4 is a process flow diagram of one or more embodiments of a method for generating a representative image for an item category including one or more items accessible via an online system 140. The online system 140 has access to various items. In some embodiments, the online system 140 has access to items available from one or more sources and allows users to select one or more items available from a source. For example, the online system 140 receives a selection of a source and an order from a user, with the order including one or more items available from the selected source. Subsequently, the online system 140 obtains the items included in the order from the selected source, and the obtained items are delivered to a location specified by the order. As another example, the online system 140 directly provides items to users, so the online system 140 receives an order including one or more items from a user and provides items in the order to the user.

To simplify identification or selection of accessible items by users, the online system 140 maintains information describing various items accessible to the online system 140. In various embodiments, the online system 140 maintains one or more item catalogs identifying items accessible to the online system 140. For example, the online system 140 maintains an item catalog for each source from which the online system 140 accesses items. Alternatively, the online system 140 maintains a single item catalog identifying items accessible to the online system 140 or provided by the online system 140. An item catalog identifies attributes of each item accessible to the online system 140 and descriptive information about each item accessible to the online system 140. In various embodiments, the online system 140 organizes an item catalog as a taxonomy having a hierarchical structure. Such a taxonomy has multiple levels, with different levels including different levels of detail about items. For example, a level of the taxonomy comprises an item category including items having one or more common attributes, and a lower level of the taxonomy from the item category identifies individual items within the item category. Alternatively, the online system 140 maintains multiple item categories, with each item category including one or more items, such as items having one or more common attributes.

In various embodiments, the online system 140 displays information describing different item categories to a user so the user may select an item category to view items within the selected item category. For example, the online system 140 identifies item categories by displaying their corresponding text names or descriptions to a user. However, displaying images corresponding to different item categories allows a user to more easily differentiate between different item categories or to select an item category. Maintaining a representative image for different categories allows the online system 140 to display representative images for one or more item categories to users to aid in identification or selection of an item category.

While the online system 140 often maintains images of items in one or more item categories, selecting an image of an item within the item category as the representative image for the item category may bias users to selecting the item used as the representative image or to selecting items having one or more attributes matching attributes of the item used as the representative image. For example, users may more frequently select items associated with a brand (e.g., a manufacturer, a distributor) that is included in an image of an item used as a representative image of the item category.

The online system 140 may attempt to mitigate influence of one or more attributes of items (e.g., a brand) when determining representative images for one or more item categories by manually-creating a representative image for an item category. However, manually creating images is time-intensive and resource-intensive, making it impractical to scale as a number of item categories increases or as a number of items in item categories increases. Alternatively, the online system 140 may use stock images or photographs of items as representative images for item categories. While using stock images or photographs may mitigate potential bias from attributes of items included in the representative image, stock images or photographs may inaccurately represent items included in the item category. Such inaccuracy between a representative image for an item category and items included in the item category reduces a frequency with which users select items from the item category for inclusion in orders or reduces a frequency with which users interact with the online system 140 to select items.

To automate generation of a representative image for an item category 400 including item 405A, item 405B, and item 405C (also referred to individually and collectively using reference number 405), while preventing presentation of one or more specific attributes of items in the item category affecting selection of items by users in the representative image, the online system 140 selects the item category 400. For example, the online system 140 retrieves an item catalog maintained for a source and selects the item category 400 from the item catalog. Alternatively, the online system 140 selects the item category 400 from an item catalog identifying items 405 offered by the online system 140.

The item category 400 includes items 405A, 405B, 405C, as well as attributes of each of item 405A, item 405B, and item 405C. In various embodiments, the item category 400 also includes an image 410A, 410B, 410B (also referred to individually or collectively using reference number 410) for each of item 405A, 405B, 405C within the item catalog. In the example of FIG. 4, image 410A is associated with item 405A, and image 410B is associated with item 405B. Similarly, image 410C is associated with item 405C in the example of FIG. 4. While FIG. 4 shows a single image 410 associated with each item 405, in various embodiments, multiple images 410 are associated with one or more items 405. For example, different images 410 associated with an item 405 include content from different portions of the item 405.

The online system 140 receives interactions with one or more of the items 405 from users. For example, the online system 140 receives interactions from users selecting one or more items 405 within the item category 400 for inclusion in one or more orders. As another example, the online system 140 receives requests from users for additional information about one or more items 405 within the item category 400. In an additional example, the online system 140 receives requests from users to store one or more items 405 within the item category 400 in one or more lists associated with corresponding users.

As users perform interactions with items 405, the online system 140 stores information describing interactions by users with items 405. For example, the online system 140 stores an entry for each interaction, with an entry including an identifier of a user, an identifier of an item 405, and a type of interaction. In some embodiments, an entry also includes a time when the user performed the interaction and may include a source from which the item is retrieved. Maintaining information about interactions by users with items 405 accessible through the online system 140 allows evaluation of rates of interaction by users with various items 405.

For the item category 400, the online system 140 retrieves historical interactions 415 by users with items within the item category 400 stored by the online system 140. Based on the historical interactions 415 with the items 405 within the item category 400, the online system 140 selects a set 420 of representative items for the item category 400. In various embodiments, the online system 140 determines a count of a specific type of interaction by users with each item 405 within the item category 400. For example, the online system 140 determines a count of previously received orders from users including item 405A, a count of previously received orders including item 405B, and a count of previously received orders including item 405B. As another example, the online system 140 determines a number of times users previously requested additional information about each of item 405A, item 405B, and item 405C. The online system 140 uses counts of the specific type of interaction performed by users with various items 405 within the item category 400 to select the set 420 of representative items. In some embodiments, the online system 140 ranks items 405 within the item category 400 based on their corresponding count of the specific type of interaction and selects items 405 having at least a threshold position in the ranking as the set 420 of representative items for the item category 400.

In the example of FIG. 4, based on the historical interactions 415 with each of item 405A, item 405B, and item 405C, the online system 140 selects item 405B and item 405C as the set 420 of representative items for the item category 400. For example, the online system 140 determines a count of orders including item 405A, a count of orders including item 405B, and a count of orders including item 405C. Based on their corresponding counts, the online system 140 ranks item 405A, item 405B, and item 405C. In the example of FIG. 4, the online system 140 selects items 405 having at least a second position in the ranking for the set 420 of representative items for the item category 400. However, in other embodiments, the online system 140 selects 405 a different number of items for the set 420 of representative items.

For each item 405 of the set 402 of representative items, the online system 140 obtains an image 410. In the example of FIG. 4, the online system 140 maintains at least one image 410 for each item 405 of the item category 400, so the online system 140 retrieves image 410B for item 405B and image 410C for item 405C. However, in other embodiments, the online system 140 transmits a request for an image 410 of an item 405 to a third party system, such as a source from which the item 405 is obtained or a third party system associated with a distributor of the item 405. In response to receiving the request, the third party system transmits an image of the item 405 to online system 140. In some embodiments, the online system 140 obtains a single image 410 for each item of the set 420 of representative items. However, in other embodiments, the online system 140 may obtain any number of images 410 for each item 405 of the set 420 of representative items.

The online system 140 applies a visual language model (VLM) 425 to one or more images 410 of each item 405 of the set 420 of representative items. As further described above in conjunction with FIG. 3, the VLM 425 comprises a multimodal generative model that receives an image and text data as input. The VLM 425 generates text data based on a received image 410 and text data. In various embodiments, text data generated by the VLM 425 comprises a text description of one or more visual features of an image 410 to which the VLM 425 was applied. For example, the VLM 425 generates sentences or phrases describing one or more visual features of an image 410 to which the VLM 425 is applied. Example visual features of an image 410 include: a description of one or more objects in the image 410, a description of one or more shapes in the image 410, a description of one or more colors in the image 410, text included in the image 410, relative positioning of objects or shapes in the image 410, or other descriptive information about the content of the image 410. As the set 420 of representative items includes items 405 within the item category 400 with which users performed a specific interaction more frequently than with other items 405 within the item category 400, applying the VLM 425 to the items 405 of the set 420 of representative items identifies visual features of items 405 of the item category 400 with which users are more likely to interact.

In the example of FIG. 4, the online system 140 applies the VLM 425 to image 410B associated with item 405B and to image 410C associated with item 405C. Applying the VLM 425 to image 410B generates a description of visual features 430A, which comprises a text description of visual features of image 410B. Similarly, applying the VLM 425 to image 410C generates description of visual features 430B, which comprises a text description of visual features of image 410C. As shown in FIG. 4, description of visual features 430A describes one or more objects included in image 410B, colors of objects included in image 410B, and text included in image 410B (e.g., text included in an object in image 410B). Also as shown in FIG. 4, description of visual features 430B describes one or more objects included in image 410C, colors of objects included in image 410C, and text included in image 410C (e.g., text included in an object in image 410C). Hence, the online system 140 generates textual descriptions of each image 410 associated with each item 405 of the set 420 of representative items through application of the VLM 425 to each image 410 associated with an item 405 of the set 420 of representative items in some embodiments.

The online system 140 applies a generative model 435, such as a large language model (LLM), to the descriptions of visual features for each image 410 to which the VLM 425 was applied to generate an image generation prompt 440. In various embodiments, the online system 140 retrieves a description of the item category 400 and applies the generative module 435 to a combination of the description of the item category 400 and to the descriptions of visual features of each image 410 associated with an item 405 of the set 420 of representative items. For example, the online system 140 generates a prompt for the generative model 435 including the description of the item category 400 and the descriptions of visual features of each image 410 associated with an item 405 of the set 420 of representative items to which the VLM 425 was applied. In various embodiments the prompt includes one or more formatting instructions affecting display characteristics of an image based on the image generation prompt 440, as further described above in conjunction with FIG. 3. Example display characteristics of the image based on the image generation prompt 440 include: a background color of an image based on the image generation prompt 440, lighting of the image based on the image generation prompt 440, contrast of the image based on the image generation prompt 440, or other characteristics affecting presentation of content by an image based on the image generation prompt 440. In various embodiments, a formatting instruction prevents presentation of one or more specific attributes of an item in an image based on the image generation prompt 440. For example, one or more formatting instructions prevent presentation of a brand associated with an item 405 in the image based on the image generation prompt 440, preventing the image based on the image generation prompt 440 from reflecting one or more specific brands.

The image generation prompt 440 comprises text describing one or more visual features of an image. The visual features described by the image generation prompt 440 are based on the one or more descriptions of visual features of images 410 associated with items 405 of the set 420 of representative items generated by the VLM 425. Hence, the generative model 430 leverages the visual features of images 410 associated with items 405 of the set 420 of representative items to generate a textual prompt identifying visual features of an image generated by an image generation model 445 in response to the image generation prompt 440. Determining the visual features described by the image generation prompt 440 from images 410 of items 405 of the set 420 of representative items, the visual features of the image generation prompt 440 reflect visual features of image 410 of items 405 within the item category 400 with which users frequently interacted.

Subsequently, the online system 140 applies the image generation model 445 to the image generation prompt 440 to generate a representative image 450 for the item category 400. As further described above in conjunction with FIG. 3, the image generation model 445 is a multimodal generative model configured to receive text data as input and to generate an image based on the received text data. For example, the image generation model 445 is a generative adversarial network that receives a text description including visual features of an image and generates an image based on the received text description. As the image generation prompt 440 comprises text describing visual features of the representative image 450, content of the image generation prompt 440 determines the visual features depicted by the representative image. For example, the image generation prompt 440 includes text descriptions of objects to be displayed by the image generated by the image generation model 445, such as text describing positioning of objects included in an image, a background color of the image, or other description of content displayed by the representative image. In various embodiments, the image generation prompt 440 includes an instruction to exclude one or more attributes from display by the representative image 450. For example, a formatting instruction in the image generation prompt 440 prevents the representative image 450 from displaying information identifying a manufacturer or a distributor of objects included in the representative image to prevent the representative image from identifying a manufacturer or a distributor of one or more items. Additionally, one or more formatting instructions included in the image generation prompt 440 include display characteristics identifying a background of the representative image 450, lighting of the representative image 450, or other characteristics affecting how the representative image 450 displays content.

The visual features included in the image generation prompt 440 based on the descriptions of visual features of images 410 of items 405 in the set 420 of representative items 405 specify content displayed by the representative image 450. This leverages historical interactions 415 by users with items 405 within the item category 400 to discern visual features of images 410 of items 405 with which users frequently interacted, so the visual features of the representative image 450 are based on visual features in images 410 of items 405 within the item category 400 with which users more frequently interacted. Further, formatting instructions included in the image generation prompt 440 further specify display of content by the representative image 450. As further described above in conjunction with FIG. 3, the online system 140 stores the representative image 450 in association with the item category 400 for subsequent retrieval and presentation to users. In various embodiments, as further described above in conjunction with FIG. 3, the online system 140 stores the representative image 450 in association with the item category 400 in response to the representative image 450 satisfying one or more criteria.

Leveraging stored historical interactions 415 with items 405 within the item category 400 allows the online system 140 to identify visual features of items 405 within the item category 400 with which users more frequently interacted. The online system 140 determines visual features to include in the representative image 450 for the item category 400 based on visual features of items that were more likely to be interacted with by users. Determining visual features of images 410 associated with one or more items 405 selected based on the historical interactions 415 prevents the representative image 450 from displaying one or more specific attributes of a particular item 405 that may bias subsequent interactions by users with items 405 within the item category 400.

Leveraging stored historical interactions with items 405 within the item category 400 allows the online system 140 to identify visual features of items within the item category 400 with which users more frequently interacted. This accounts for relevance of different items 405 within the item category 400 to users to limit a number of items 405 for which the online system 140 evaluates images 410. In addition to reducing computational resources allocated to determining visual features of images 410 of items 405, limiting identification of visual features to images 410 of items 405 with which users more frequently interacted tailors visual features for generating the representative image 450 to visual features of items 405 more likely to be interacted with by users.

Combining the descriptions of visual features of images 410 associated with items 405 of the set 420 of representative items with one or more formatting instructions for a generative model 435 refines the visual features of the representative image 450 to modify visual features included in the representative image 450. For example, combining formatting instructions with the descriptions of visual features of images associated with items of the set 420 of representative items prevents display of one or more specific attributes of items 405 by the representative image 450, while basing visual features of the representative image 450 on visual features of items within the item category 400 with which users more frequently interacted. This enables the online system 140 to generate a representative image of the item category 400 that does not display including specific attributes present in images 410 of items 405 that may bias users towards selection of specific items 405 within the item category 400. Hence, leveraging historical interactions 415 with items 405 in the item category 400 by users and a combination of multiple machine-learning models (e.g., the VLM 425, the generative model 435, and the image generation model 445) to automatically generate the representative image 450 for the item category 400 generates a representative image 450 of the item category 400 including visual features of items 405 within the item category 400 with which users frequently performed one or more specific interactions, while limiting attributes of items present in images 410 that are displayed by the representative image 450.

The foregoing description of the embodiments has been presented for the purpose of illustration; many modifications and variations are possible while remaining within the principles and teachings of the above description.

Any of the steps, operations, or processes described herein may be performed or implemented with one or more hardware or software modules, alone or in combination with other devices. In some embodiments, a software module is implemented with a computer program product comprising one or more computer-readable media storing computer program code or instructions, which can be executed by a computer processor for performing any or all of the steps, operations, or processes described. In some embodiments, a computer-readable medium comprises one or more computer-readable media that, individually or together, comprise instructions that, when executed by one or more processors, cause the one or more processors to perform, individually or together, the steps of the instructions stored on the one or more computer-readable media. Similarly, a processor comprises one or more processors or processing units that, individually or together, perform the steps of instructions stored on a computer-readable medium.

Embodiments may also relate to a product that is produced by a computing process described herein. Such a product may store information resulting from a computing process, where the information is stored on a non-transitory, tangible computer-readable medium and may include a computer program product or other data combination described herein.

The description herein may describe processes and systems that use machine-learning models in the performance of their described functionalities. A “machine-learning model,” as used herein, comprises one or more machine-learning models that perform the described functionality. Machine-learning models may be stored on one or more computer-readable media with a set of weights. These weights are parameters used by the machine-learning model to transform input data received by the model into output data. The weights may be generated through a training process, whereby the machine-learning model is trained based on a set of training examples and labels associated with the training examples. The training process may include: applying the machine-learning model to a training example, comparing an output of the machine-learning model to the label associated with the training example, and updating weights associated with the machine-learning model through a back-propagation process. The weights may be stored on one or more computer-readable media, and are used by a system when applying the machine-learning model to new data.

The language used in the specification has been principally selected for readability and instructional purposes, and it may not have been selected to narrow the inventive subject matter. It is therefore intended that the scope of the patent rights be limited not by this detailed description, but rather by any claims that issue on an application based hereon.

As used herein, the terms “comprises,” “comprising,” “includes,” “including,” “has,” “having,” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive “or” and not to an exclusive “or.” For example, a condition “A or B” is satisfied by any one of the following: A is true (or present) and B is false (or not present); A is false (or not present) and B is true (or present); and both A and B are true (or present). Similarly, a condition “A, B, or C” is satisfied by any combination of A, B, and C being true (or present). As a non-limiting example, the condition “A, B, or C” is satisfied when A and B are true (or present) and C is false (or not present). Similarly, as another non-limiting example, the condition “A, B, or C” is satisfied when A is true (or present) and B and C are false (or not present).

What is claimed is:

1. A method, performed at a computer system comprising a processor and a computer-readable medium, comprising:
identifying an item category maintained by the computer system, the item category including one or more items accessible to the computer system;
selecting, by the computer system, a set of representative items from the item category based on historical interactions by users with items within the item category;
obtaining one or more images corresponding to each item of the set of representative items;
identifying visual features of each image of a representative item by applying a visual language model to images of items of the set of representative items;
generating an image generation prompt for an image generation model by applying a generative model to a description of the item category and to the visual features identified for images of items of the set of representative items, the image generation prompt describing one or more visual features based on the visual features of items of the set of representative items;
generating a representative image for the item category by applying the image generation model to the prompt, the representative image including the one or more visual features described by the image generation prompt; and
sending, to a device associated with a user, the generated representative image for the item category in a user interface that presents information related to the item category, wherein the sending causes the device to display the user interface with the generated representative image for the item category.

2. The method of claim 1, further comprising:
storing the representative image at the computer system in association with the item category.

3. The method of claim 2, wherein storing the representative image at the computer system in association with the item category comprises:
storing the representative image at the computer system in association with the item category in response to the representative image satisfying one or more criteria.

4. The method of claim 3, wherein storing the representative image at the computer system in association with the item category in response to the representative image satisfying one or more criteria comprises:
generating a description of visual features of the representative image by applying the visual language model to the representative image;
computing a percentage of visual features specified by the image generation prompt that match visual features specified by the description of visual features of the representative image;
comparing the percentage of visual features specified by the image generation prompt that match visual features specified by the description of visual features of the representative image to a threshold percentage; and
in response to the percentage of visual features specified by the image generation prompt that match visual features specified by the description of visual features of the representative image equaling or exceeding a threshold percentage, storing the representative image at the computer system in association with the item category.

5. The method of claim 4, wherein storing the representative image at the computer system in association with the item category in response to the representative image satisfying one or more criteria comprises:
in response to the percentage of visual features specified by the image generation prompt that match visual features specified by the description of visual features of the representative image equaling or exceeding the threshold percentage, generating an image modification prompt that includes the description of visual features of the representative image and including visual features from the image generation prompt that are not included in the image generation prompt;
generating a modified representative image by applying the image generation model to the image modification prompt; and
storing the modified representative image in association with the item category in response to the modified representative image satisfying one or more criteria.

6. The method of claim 1, wherein selecting, by the computer system, the set of representative items within the item category based on historical interactions by users with items within the item category comprises:
generating a count of a specific type of interaction performed by users with each item within the item category based on the historical interactions by users with items within the item category; and
selecting the set of representative items based on the counts generated for each of at least a set of items within the item category.

7. The method of claim 6, wherein selecting the set of representative items based on the counts generated for each of at least a set of items within the item category comprises:
ranking at least the set of items within the item category based on their counts, with items having larger counts having higher positions in the ranking; and
selecting items of the set of items having at least a threshold position in the ranking having at least a threshold position in the ranking.

8. The method of claim 1, wherein generating the image generation prompt comprises including, in the image generation prompt, a formatting instruction preventing the representative image from displaying one or more attributes of items within the item category, the one or more attributes specified by the formatting instruction.

9. The method of claim 8, wherein an attribute of items within the item category comprises an identifier of a brand associated with one or more items within the item category.

10. The method of claim 1, wherein generating the image generation prompt comprises including, in the image generation prompt, one or more formatting instructions that specify one or more display characteristics of the representative image.

11. A computer program product comprising a non-transitory computer readable storage medium having instructions encoded thereon that, when executed by a processor, cause the processor to perform steps comprising:
identifying an item category maintained by an online system, the item category including one or more items accessible to the online system;
selecting, by the online system, a set of representative items from the item category based on historical interactions by users with items within the item category;
obtaining one or more images corresponding to each item of the set of representative items;
identifying visual features of each image of a representative item by applying a visual language model to images of items of the set of representative items;
generating an image generation prompt for an image generation model by applying a generative model to a description of the item category and to the visual features identified for images of items of the set of representative items, the image generation prompt describing one or more visual features based on the visual features of items of the set of representative items;
generating a representative image for the item category by applying the image generation model to the prompt, the representative image including the one or more visual features described by the image generation prompt; and
sending, to a device associated with a user, the generated representative image for the item category in a user interface that presents information related to the item category, wherein the sending causes the device to display the user interface with the generated representative image for the item category.

12. The computer program product of claim 11, wherein the non-transitory computer readable medium further has instructions encoded thereon that, when executed by the processor, cause the processor to perform steps comprising:
storing the representative image at the online system in association with the item category.

13. The computer program product of claim 12, wherein storing the representative image at the online system in association with the item category comprises:
storing the representative image at the online system in association with the item category in response to the representative image satisfying one or more criteria.

14. The computer program product of claim 13, wherein storing the representative image at the online system in association with the item category in response to the representative image satisfying one or more criteria comprises:
generating a description of visual features of the representative image by applying the visual language model to the representative image;
computing a percentage of visual features specified by the image generation prompt that match visual features specified by the description of visual features of the representative image;
comparing the percentage of visual features specified by the image generation prompt that match visual features specified by the description of visual features of the representative image to a threshold percentage; and
in response to the percentage of visual features specified by the image generation prompt that match visual features specified by the description of visual features of the representative image equaling or exceeding a threshold percentage, storing the representative image at the computer system in association with the item category.

15. The computer program product of claim 14, wherein storing the representative image at the online system in association with the item category in response to the representative image satisfying one or more criteria comprises:
in response to the percentage of visual features specified by the image generation prompt that match visual features specified by the description of visual features of the representative image equaling or exceeding the threshold percentage, generating an image modification prompt that includes the description of visual features of the representative image and including visual features from the image generation prompt that are not included in the image generation prompt;
generating a modified representative image by applying the image generation model to the image modification prompt; and
storing the modified representative image in association with the item category in response to the modified representative image satisfying one or more criteria.

16. The computer program product of claim 12, wherein selecting, by the online system, the set of representative items within the item category based on historical interactions by users with items within the item category comprises:
generating a count of a specific type of interaction performed by users with each item within the item category based on the historical interactions by users with items within the item category; and
selecting the set of representative items based on the counts generated for each of at least a set of items within the item category.

17. The computer program product of claim 16, wherein selecting the set of representative items based on the counts generated for each of at least a set of items within the item category comprises:
ranking at least the set of items within the item category based on their counts, with items having larger counts having higher positions in the ranking; and
selecting items of the set of items having at least a threshold position in the ranking having at least a threshold position in the ranking.

18. The computer program product of claim 11, wherein generating the image generation prompt comprises including, in the image generation prompt, a formatting instruction preventing the representative image from displaying one or more attributes of items within the item category, the one or more attributes specified by the formatting instruction.

19. The computer program product of claim 18, wherein an attribute of items within the item category comprises an identifier of a brand associated with one or more items within the item category.

20. A system comprising:
a processor; and
a non-transitory computer readable storage medium having instructions encoded thereon that, when executed by the processor, cause the processor to perform steps comprising:
identifying an item category maintained by an online system, the item category including one or more items accessible to the online system;
selecting, by the online system, a set of representative items from the item category based on historical interactions by users with items within the item category;
obtaining one or more images corresponding to each item of the set of representative items;
identifying visual features of each image of a representative item by applying a visual language model to images of items of the set of representative items;
generating an image generation prompt for an image generation model by applying a generative model to a description of the item category and to the visual features identified for images of items of the set of representative items, the image generation prompt describing one or more visual features based on the visual features of items of the set of representative items;
generating a representative image for the item category by applying the image generation model to the prompt, the representative image including the one or more visual features described by the image generation prompt; and
sending, to a device associated with a user, the generated representative image for the item category in a user interface that presents information related to the item category, wherein the sending causes the device to display the user interface with the generated representative image for the item category.
